(19) United States
(12) Patent Application Publication
(10) Pub. No.: US 2010/0166095 A1
(43) Pub. Date: Jul. 1, 2010

(54) COOPERATIVE DIVERSITY METHOD AND COOPERATIVE DIVERSITY SYSTEM USING OPPORTUNISTIC RELAYING

(75) Inventors: Jae Hong LEE, Seoul (KR); Dongwoo LEE, Seoul (KR)

Correspondence Address: FENWICK & WEST LLP, SILICON VALLEY CENTER, 801 CALIFORNIA STREET, MOUNTAIN VIEW, CA, 94041, US

(73) Assignee: SNU R&DB Foundation, Seoul (KR)

(21) Appl. No.: 12/391,590

(22) Filed: Feb. 24, 2009

(30) Foreign Application Priority Data
Dec. 30, 2008 (KR) 10-2008-0136391

(51) Int. Cl. H04L 1/02

(52) U.S. Cl. 375/267

(57) ABSTRACT

There are provided a cooperative diversity method and a cooperative diversity system using opportunistic relaying. In cooperative diversity wireless communications, an optimum relay is selected considering an interference effect between adjacent cells, and the selected relay transmits a data signal received from a transmitter to a receiver. Accordingly, an optimum relay is selected considering interference between channels not only in a single cell environment but also a multi cell environment, and a signal is transmitted to a receiver through the selected relay, thereby increasing transmission efficiency and improving reliability.

### CROSS-REFERENCE TO RELATED APPLICATION

This application claims the benefit under 35 U.S.C. § 119(a) from Republic of Korea Patent Application No. 10-2008-0136391, filed on Dec. 30, 2008 in the Korean Intellectual Property Office, the entire disclosure of which is hereby incorporated by reference.

### BACKGROUND

1. Field

This disclosure relates to a cooperative diversity method and a cooperative diversity system in a wireless communications system.

2. Description of the Related Art

In wireless communications environments, a multiple-input and multiple-output (MIMO) system has been known as an effective method for removing channel fading and increasing a diversity gain. However, in many cases, use of multiple antennas is not applicable in wireless terminals because of limitations such as its size, cost and hardware complexity.

To overcome such limitations, a cooperative diversity method has been proposed, in which multiple terminals each having a single antenna share their resources and cooperate with one another in data transmission so as to obtain a gain of the MIMO system.

When multiple relays are used in the cooperative diversity technique, an enhanced diversity gain can be obtained as compared with when one relay is used. However, an existing signal transmitting/receiving method using cooperative diversity has problems in that a complicated code design is required, overall channel state information (CSI) has to be extracted from a receiver (destination), exact synchronization is required between transmitters located at different positions, and the like.

Further, most of previous work has focused on single cell environments and ignored the effects of interference from neighboring cells.

### SUMMARY

Various methods may be used in the cooperative diversity method. This disclosure provides a method for selecting an optimum relay out of a plurality of relays.

This disclosure also provides a cooperative diversity method and a cooperative diversity system, which can transmit signals by selecting an optimum relay not only in a single cell wireless environment but also in a multi cell wireless environment.

In one aspect, there is provided a cooperative diversity method using opportunistic relaying, which includes transmitting a signal to a plurality of relays from a transmitter; selecting a relay maximizing a signal-to-interference-plus-noise ratio (SINR) between a relay and a receiver out of the plurality of relays; and transmitting the signal transmitted from the transmitter to the receiver through the selected relay.

The selecting of the relay may include classifying relays capable of decoding the received signal out of the plurality of relays; and selecting a relay maximizing the SINR between the relay and the receiver out of the classified relays.

The selecting of the relay maximizing the SINR between the relay and the receiver may be selecting a relay maximizing an instantaneous channel gain between the relay and the receiver.

The instantaneous channel gain may be the square value of the absolute value of channel fading between the relay and the receiver.

In another aspect, there is provided a cooperative diversity system using opportunistic relaying, which includes a transmitter transmitting a signal to a plurality of relays; a controller selecting a relay maximizing an SINR between a relay and a receiver out of the plurality of relays receiving the signal transmitted from the transmitter; and a receiver receiving the signal transmitted from the relay selected by the controller.

The controller may classify relays capable of decoding the received signal out of the plurality of relays and select a relay maximizing the SINR between the relay and the receiver out of the classified relays.

The selecting of the relay maximizing the SINR between the relay and the receiver may be selecting a relay maximizing an instantaneous channel gain between the relay and the receiver.

### BRIEF DESCRIPTION OF THE DRAWINGS

The above and other aspects, features and advantages of the disclosed exemplary embodiments will be more apparent from the following detailed description taken in conjunction with the accompanying drawings.

FIG. 1 is a conceptual view showing an example of a multi cell environment having M+1 cells.

FIG. 2 is a block diagram showing a cooperative diversity system using opportunistic relaying according to an exemplary embodiment.

FIG. 3 is a flowchart illustrating a cooperative diversity method using opportunistic relaying according to an exemplary embodiment.

FIG. 4 is a graph comparing performance of the cooperative diversity method using the opportunistic relaying according to the exemplary embodiment with performance of an existing direct transmission method in view of an outage probability vs. a signal-to-noise ratio (SNR).

FIG. 5 is a graph comparing performance of the cooperative diversity method using the opportunistic relaying according to the exemplary embodiment with performance of the existing direct transmission method in view of an outage probability vs. a symmetric interference factor.

FIG. 6 is a graph comparing performance of the cooperative diversity method using the opportunistic relaying according to the exemplary embodiment with performance of the existing direct transmission method in view of an outage probability vs. a non-symmetric interference factor.

FIG. 7 is a graph comparing performance of the cooperative diversity method using the opportunistic relaying according to the exemplary embodiment with performance of the existing direct transmission method in view of an outage probability vs. number of available relays.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Definitions of terms used herein are provided as follows.

Cooperative diversity refers to a technique in which, when a transmitter (source) and a receiver (destination) transmit and receive data signals to and from each other in a signal transmitting/receiving system having a plurality of relays each having a single antenna, a data signal transmitted by the transmitter is received by all the plurality of relays, a relay having superior efficiency is selected out of the plurality of relays, and the selected relay then transmits the data signal received from the transmitter to the receiver.

Opportunistic relaying refers to a technique in which, when the cooperative diversity is performed, a relay having the best channel state between the relay and a receiver is selected considering even an interference phenomenon between adjacent cells, and the selected relay transmits a data signal received from a transmitter to the receiver. That is, the opportunistic relaying refers to a relay selection technique considering even an interference phenomenon in multiple cells in a cooperative diversity system.

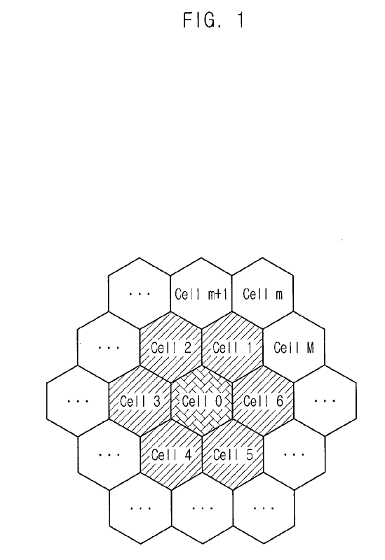

FIG. 1 is a conceptual view showing an example of a multi cell environment having M+1 cells.

It is assumed that signals are transmitted in a model of a simple, ideal synchronous and linear cell type.

Referring to FIG. 1, a multi cell environment including M+1 cells from Cell 0 to Cell M is shown as a wireless communications environment. For example, when data transmission/reception is performed in Cell 0, a transmitter in Cell 0 transmits a data signal to a plurality of relays in Cell 0, and the data signal received by a relay selected out of the plurality of relays is transmitted to a receiver.

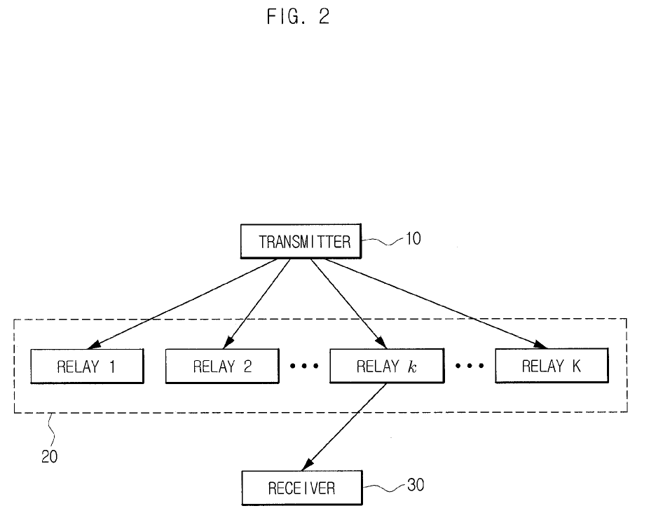

FIG. 2 is a block diagram showing a cooperative diversity system using opportunistic relaying according to an exemplary embodiment.

Referring to FIGS. 1 and 2, the cooperative diversity system using the opportunistic relaying includes a transmitter 10, a plurality of relays 20, a receiver 30, and a controller (not shown) that selects a relay out of the plurality of relays which maximizes a signal-to-interference-plus-noise ratio (SINR) between the relay and the receiver 30.

The transmitter includes all sources from which a signal is transmitted, and the receiver includes all destinations at which the signal transmitted from the transmitter is finally received. The transmitter or the receiver is not limited to a specific device.

At this time, the cooperative diversity system using the opportunistic relaying may be configured in a single cell or may be configured in a wireless communications environment of multiple cells as shown in FIG. 1. The cooperative diversity system using the opportunistic relaying according to the exemplary embodiment may be applied to a single cell environment or a multi cell environment. Hereinafter, a multi cell environment will be described as an exemplary embodiment.

In a hexagonal multi cell model having M+1 cells, a single transmitter sₘ transmits a data signal to a single receiver dₘ in cooperation with K relays each having a single antenna for an m-th cell. A set of the K relays each having a single antenna for the m-th cell may be represented by Rₘ={r_{m,1}, r_{m,2}, . . . , r_{m,k}, . . . , r_{m,K}}.

A relay may perform communications between the transmitter and the receiver, and may block a direct path between the transmitter and the receiver.

Under half-duplex constrains, communications between the transmitter and the receiver is performed using two time slots. During a first time slot, the transmitter transmits a data signal to the K relays in its own cell, and all the relays receive the data signal. Simultaneously, each of the relays receives interference signals from M adjacent cells.

The plurality of relays decode the data signal received from the transmitter and the decoded data signal is re-encoded. During a second time slot, a relay selected from the K relays transmits the re-encoded data signal to the receiver. At this time, it can be seen that the total transmission power is identically distributed to the transmitter and the selected relay. In the opportunistic relaying, the total transmission power may be identical to or smaller than that in direct transmission without cooperation with relays.

For example, it is assumed that Cell 0 positioned at the center in the multi cells of FIG. 1 is interfered by M adjacent cells. Signals received during the first and second time slots will be described.

During the first time slot, a k-th relay receives a signal from the transmitter and is interfered by transmitters in the M adjacent cells. At this time, the signal received by the k-th relay is represented by Equation 1.

$${y}_{1 , {r}_{0 , k}} = {a}_{{s}_{0} , {r}_{0 , k}} {x}_{{s}_{0} , {r}_{0 , k}} + {\sum }_{m = 1}^{M} {α}_{m , k} {a}_{{s}_{m} , {r}_{0 , k}} {x}_{{s}_{m} , {r}_{0 , k}} + {n}_{1 , k} . \qquad Equation 1$$

Here, a_{i,j} denotes a fading coefficient from an i-th terminal to a j-th terminal, and x_{i,j} denotes a data transmitted from the i-th terminal to the j-th terminal. α_{m,k} denotes an interference coefficient between the transmitter in the m-th cell and the k-the relay in the center cell. At this time, α_{m,k} is in a range of [0, 1]. n_{1,k} denotes a noise in the k-th relay.

r_{m,k} is selected for performing the opportunistic relaying between the K relays in the m-th cell. In case the receiver receives a data signal from the selected relay and is interfered by the M adjacent cells during the second time slot, the signal received by the receiver is represented by Equation 2.

$${y}_{2 , {d}_{0}} = {a}_{{r}_{0 , k} , {d}_{0}} {x}_{{r}_{0 , k} , {d}_{0}} + {\sum }_{m = 1}^{M} {β}_{m} {a}_{{r}_{m , k} , {d}_{0}} {x}_{{r}_{m , k} , {d}_{0}} + {n}_{2} . \qquad Equation 2$$

Here, βₘ denotes an interference coefficient between the relay selected in the m-th cell and the receiver in the center cell. At this time, βₘ is in a range of [0, 1]. n₂ denotes a noise in the receiver.

As such, signal distortion between the signal received by the relay during the first time slot and the signal received by the receiver during the second time slot occurs due to the interference coefficients from the adjacent cells.

The controller selects a relay capable of maximizing transmission efficiency out of the plurality of relays, and the relay selected by the controller transmits a data signal received from the transmitter to the receiver. At this time, the controller according to the exemplary embodiment selects an optimum relay considering an interference effect between adjacent cells in the wireless communications environment of multiple cells.

Hereinafter, a method by which the controller selects a relay will be described in detail.

During the second time slot, the controller classifies relays capable of decoding the received data signal out of the plurality of relays and selects an optimum relay out of the classified relays based on a predetermined standard.

When a set of the entire relays is R₀ in the center cell and a set of the decodable relays in the entire relays is D₀ in the center cell, D₀ is defined as follows.

$${D}_{0} {=}^{△} \{ {r}_{0 , k} ∈ {R}_{0} \text{:} \frac{1}{2} {log}_{2} ( 1 + \frac{{P}_{{s}_{0}} {\vert {a}_{{s}_{0} , {r}_{0 , k}} \vert}^{2}}{{N}_{0} + {\sum }_{m = 1}^{M} {α}_{m , k}^{2} {P}_{{s}_{m}} {\vert {a}_{{s}_{m} , {r}_{0 , k}} \vert}^{2}} ) \geq R \}$$

Here, Pₛ_{ₘ}=|xₛ_{ₘ}_{,r}_{_{m,k}}|², which denotes the square value of the absolute value of the data signal between the k-th relay of the m-th cell and the transmitter of the m-th cell. R (bits/s/Hz) denotes target spectrum efficiency. “Δ” means delta equal, that is equal by definition.

D0 denotes a set of relays successfully decoding the data signal received from the transmitter in the center cell.

When r_{0,k} is selected between the K relays, the mutual information between the transmitter and the receiver is represented by Equation 3.

$$I = \frac{1}{2} log ( 1 + S I N R ) . \qquad Equation 3$$

In Equation 3, SINR denotes a signal-to-interference-plus-noise ratio and is represented by Equation 4.

$$\begin{matrix}S I N R = \frac{{P}_{{r}_{0 , k}} {\vert {a}_{{r}_{0 , k} , {d}_{0}} \vert}^{2}}{{N}_{0} + {\sum }_{m = 1}^{M} {β}_{m}^{2} {P}_{{r}_{m , k}} {\vert {a}_{{r}_{m , k} , {d}_{0}} \vert}^{2}} \\ = S I N R \cdot \frac{{\vert {a}_{{r}_{0 , k} , {d}_{0}} \vert}^{2}}{1 + {\sum }_{m = 1}^{M} {β}_{m}^{2} S I N {R}_{m} {\vert {a}_{{r}_{m , k} , {d}_{0}} \vert}^{2}} .\end{matrix} \qquad Equation 4$$

Here, Pᵣ_{_{0,k}}=|xᵣ_{_{0,k}}_{,d}_{₀}|², Pᵣ_{_{m,k}}=|xᵣ_{_{m,k}}_{,d}_{₀}|², SNR=Pᵣ_{_{0,k}}/N₀, and SNRₘ=Pᵣ_{_{m,k}}/N₀.

The selection of a relay maximizing the mutual information may mean the selection of an optimum relay providing improved diversity efficiency. That is, the mutual information I in Equation 3 is maximized by maximizing the SINR in Equation 4. The SINR is maximized by maximizing the square value of the absolute value of channel fading which is an instantaneous channel gain between the relay and the receiver.

Accordingly, in the cooperative diversity system using the cooperative relaying according to the exemplary embodiment, the controller can select the best relay by maximizing the mutual information, maximizing the SINR, maximizing the square value of the absolute value of the channel fading or maximizing the instantaneous channel gain between the relay and the receiver, which is represented by Equation 5.

$${r}_{0 , j} = arg {max}_{{r}_{0 , k} ∈ {D}_{0}} I = arg {max}_{{r}_{0 , k} ∈ {D}_{0}} {γ}_{{r}_{0 , k} , {d}_{0}} . \qquad Equation 5$$

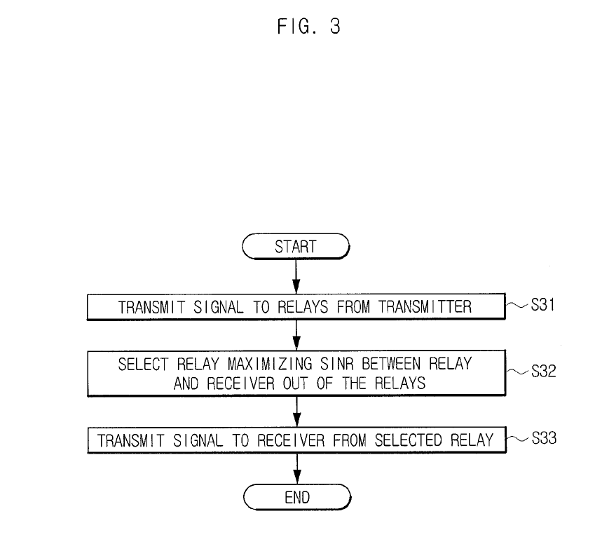

FIG. 3 is a flowchart illustrating a cooperative diversity method using opportunistic relaying according to an exemplary embodiment.

Referring to FIG. 3, the cooperative diversity method using the opportunistic relaying includes transmitting a signal to a plurality of relays from a transmitter (S31); selecting a relay maximizing an SINR between a relay and a receiver out of the plurality of relays (S32); and transmitting the signal transmitted from the transmitter to the receiver through the selected relay (S33).

The method for selecting the relay has been described in detail in the aforementioned cooperative diversity system using the opportunistic relaying.

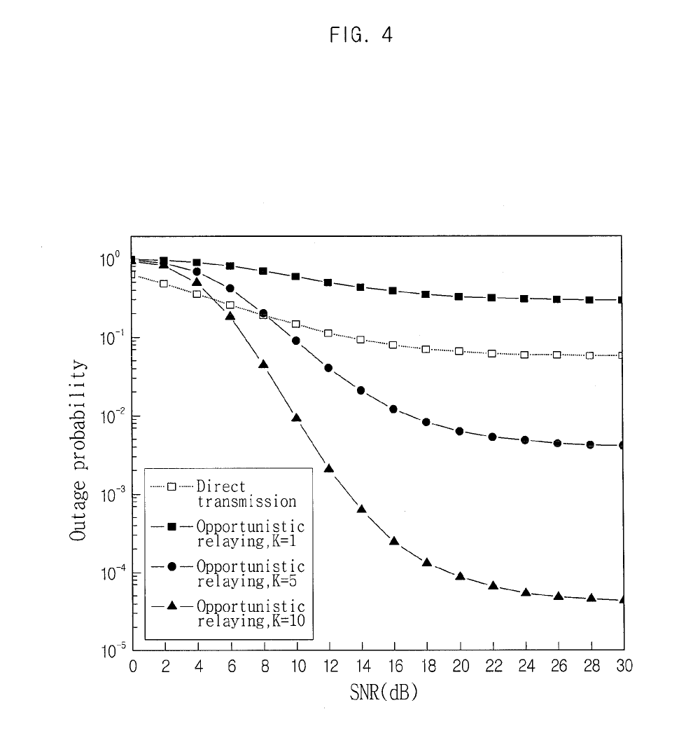

FIG. 4 is a graph comparing performance of the cooperative diversity method using the opportunistic relaying according to the exemplary embodiment with performance of an existing direct transmission method in view of an outage probability vs. a signal-to-noise ratio (SNR).

Referring to FIG. 4, it can be seen that as the number of available relays is increased, the outage possibility of the cooperative diversity method using the opportunistic relaying is decreased, thereby improving performance.

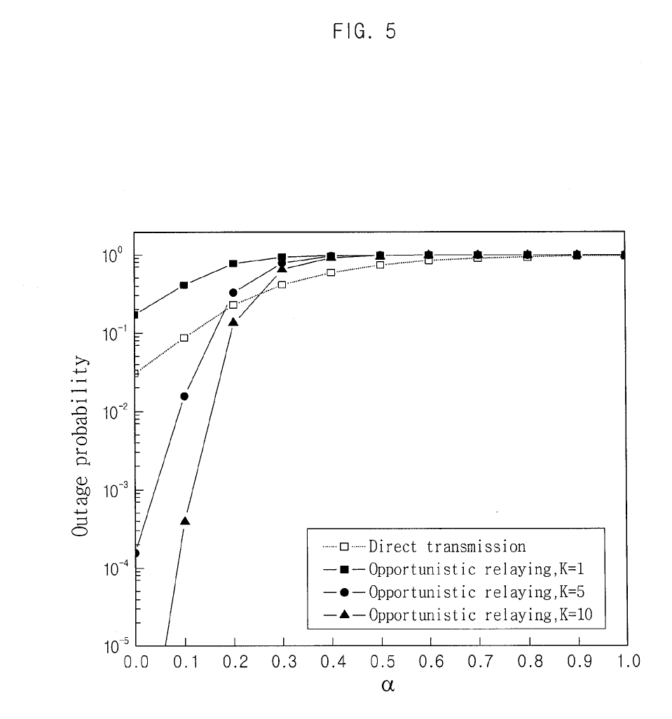

FIG. 5 is a graph comparing performance of the cooperative diversity method using the opportunistic relaying according to the exemplary embodiment with performance of the existing direct transmission method in view of an outage probability vs. a symmetric interference factor.

Referring to FIG. 5, it can be seen that, in the symmetric interference condition in which the value of SNR is fixed and the values of α and β are equal to each other, as the number of available relays is increased, the outage possibility of the cooperative diversity method using the opportunistic relaying is decreased, thereby improving performance.

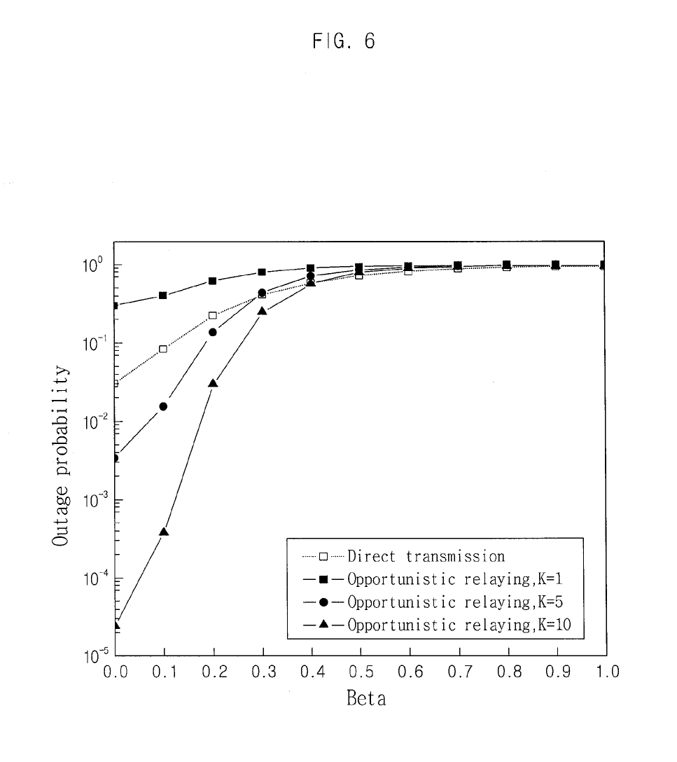

FIG. 6 is a graph comparing performance of the cooperative diversity method using the opportunistic relaying according to the exemplary embodiment with performance of the existing direct transmission method in view of an outage probability vs. a non-symmetric interference factor.

Referring to FIG. 6, it can be seen that, in the non-symmetric interference condition in which the values of SNR and α are fixed and the value of β is changed, as the number of available relays is increased, the outage possibility of the cooperative diversity method using the opportunistic relaying is decreased, thereby improving performance.

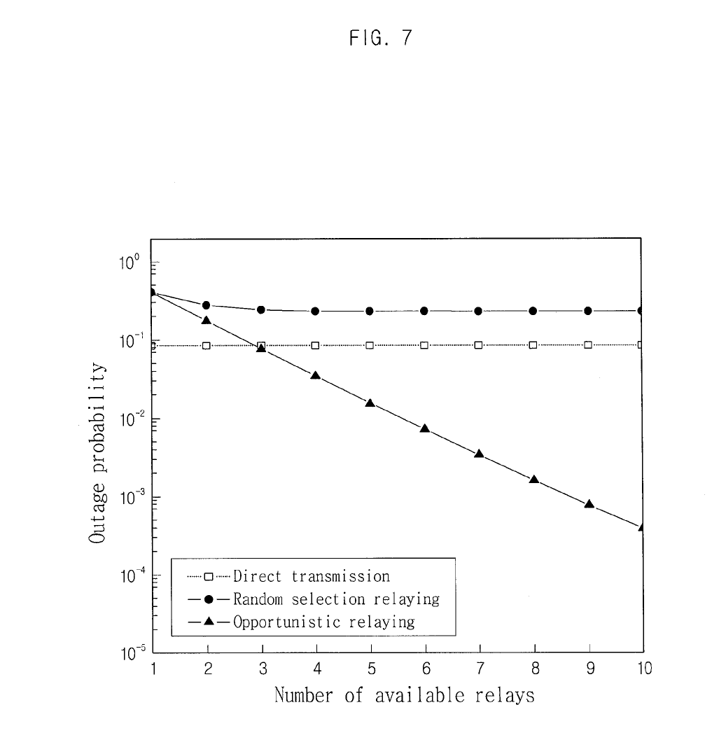

FIG. 7 is a graph comparing performance of the cooperative diversity method using the opportunistic relaying according to the exemplary embodiment with performance of the existing direct transmission method in view of an outage probability vs. number of available relays.

Referring to FIG. 7, when comparing the direct transmission method, the cooperative diversity method using random selection relaying and the cooperative diversity method using the opportunistic relaying in the condition in which the values of SNR, α and β are fixed, it can be seen that as the number of available relays is increased, the outage possibility of the cooperative diversity method using the opportunistic relaying is decreased, thereby improving performance.

According to the exemplary embodiments disclosed herein, an optimum relay is selected considering interference between channels not only in a single cell environment but also a multi cell environment, and a signal is transmitted to a receiver through the selected relay, thereby increasing transmission efficiency and improving reliability.

According to the exemplary embodiments disclosed herein, the cooperative diversity method can lower an outage probability with respect to the same SNR, and lower an outage probability with respect to an interference coefficient and the like, as compared with in the existing cooperative diversity method, thereby increasing a diversity gain.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. A cooperative diversity method using opportunistic relaying, comprising:
transmitting a signal to a plurality of relays from a transmitter;
selecting a relay maximizing a signal-to-interference-plus-noise ratio (SINR) between a relay and a receiver out of the plurality of relays; and
transmitting the signal transmitted from the transmitter to the receiver through the selected relay.

2. The cooperative diversity method according to claim 1, wherein the selecting of the relay comprises:
classifying relays capable of decoding the received signal out of the plurality of relays; and
selecting a relay maximizing the SINR between the relay and the receiver out of the classified relays.

3. The cooperative diversity method according to claim 1, wherein the selecting of the relay maximizing the SINR between the relay and the receiver comprises selecting a relay maximizing an instantaneous channel gain between the relay and the receiver.

4. The cooperative diversity method according to claim 3, wherein the instantaneous channel gain is the square value of the absolute value of channel fading between the relay and the receiver.

5. A cooperative diversity system using opportunistic relaying, comprising:
a transmitter transmitting a signal to a plurality of relays;
a controller selecting a relay maximizing a signal-to-interference-plus-noise ratio (SINR) between a relay and a receiver out of the plurality of relays receiving the signal transmitted from the transmitter; and
a receiver receiving the signal transmitted from the relay selected by the controller.

6. The cooperative diversity system according to claim 5, wherein the controller classifies relays capable of decoding the received signal out of the plurality of relays and selects a relay maximizing the SINR between the relay and the receiver out of the classified relays.

7. The cooperative diversity system according to claim 5, wherein the selecting of the relay maximizing the SINR between the relay and the receiver comprises selecting a relay maximizing an instantaneous channel gain between the relay and the receiver.

8. The cooperative diversity system according to claim 7, wherein the instantaneous channel gain is the square value of the absolute value of channel fading between the relay and the receiver.
